(19) United States
(12) Patent Application Publication
(10) Pub. No.: US 2007/0091543 A1
(43) Pub. Date: Apr. 26, 2007

(54) Layer and method for microbattery protection by a ceramic-metal double layer

(75) Inventors: Adrien Gasse, Grenoble (FR); Catherine Brunet-Manquat, Gieres (FR); Bernard Andre, Quaix (FR)

Correspondence Address: HUTCHISON LAW GROUP PLLC, PO BOX 31686, RALEIGH, NC, 27612, US

(73) Assignee: COMMISSARIAT A L'ENERGIE ATOMIQUE, Paris (FR)

(21) Appl. No.: 10/574,756

(22) PCT Filed: Oct. 14, 2004
(86) PCT No.: PCT/FR04/02621

§ 371 Date: Apr. 13, 2006

(30) Foreign Application Priority Data
Oct. 16, 2003 (FR) 0350690

(51) Int. Cl. H01G 4/002; B05D 5/12; H01G 4/06

(52) U.S. Cl. 361/272; 361/311; 427/79; 427/123; 427/124

(57) ABSTRACT

A protective layer (7) formed of a metal or metal alloy capable of absorbing considerable thermomechanical deformations without causing fissures to appear is described for energy storage systems. In particular, the metal or the metal alloy has an expansion coefficient less than 6.10^{-6 °} C.⁻¹.
The protective layer may be associated with a second layer (6) in insulating ceramic. A deposition method is described.
Said protection is principally advantageous for microbatteries (10), the constituents of which are reactive to air.

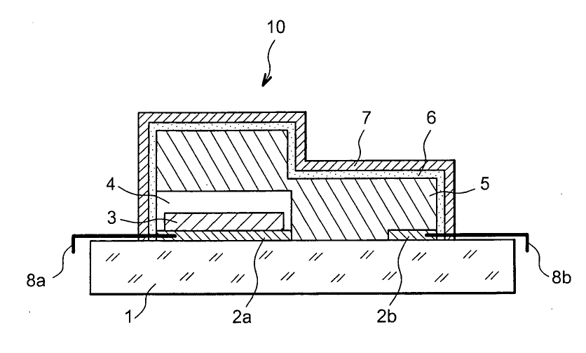

### TECHNICAL FIELD

The invention concerns energy storage systems in general.

More specifically, the invention concerns the protection of said systems vis-a-vis air, particularly for systems deposited on a substrate.

### STATE OF THE PRIOR ART

“Energy storage systems” are very often miniaturised. They comprise, among other things, microbatteries and micro-supercapacities, in other words systems obtained by deposition of materials on a substrate. These materials are, usually, reactive to air and/or to its components (oxygen, nitrogen, humidity).

The term microbattery includes not just electrochemical systems comprising lithium and compounds thereof such as glasses based on lithium, but also electrochemical systems comprising alkali metals such as sodium and potassium, or even alkaline-earth metals such as beryllium or magnesium. The term micro-supercapacity covers, in particular, storage systems in which the electrodes may be based on carbon or metal oxides such as the oxides of ruthenium, iridium, tantalum and manganese.

For convenience and in the description that follows, the term MICROBATTERY will be used indiscriminately to designate any energy storage system previously described, but it is understood that its use must not be interpreted in a restrictive manner.

Microbatteries are usually obtained in thin films on a rigid substrate made out of silicon, ceramic or glass, or on a flexible substrate made out of polymer such as Kapton or benzocyclobutene polymer. They can also be associated with integrated circuits.

Microbatteries comprise reactive elements; in particular, the anode is very often made of lithium. Metallic lithium reacts rapidly on exposure to atmospheric elements such as oxygen, nitrogen, carbon dioxide and water vapour. In order to assure a good resistance of the systems and allow a long working life, one therefore assures a protection against air. The other components of a microbattery, for instance the cathodic films or the electrolyte, even though they are normally less reactive than the anode, also benefit from a protection against air.

In order to protect the different elements against air and its components, it has been proposed to encapsulate the microbatteries, in other words to coat them with a layer of material isolating the different constituents from the ambient air. Different materials have been proposed to achieve this encapsulation: thus, the document U.S. Pat. No. 5,561,004 suggests the use of polymers. including in particular parylene, the use of iron, aluminium, titanium, nickel, vanadium, manganese or chrome, or even the use of LiPON®, i.e. a lithium phosphorous oxynitride on lithium electrode. These solutions are not optimal: for example, the polymers are not impermeable to air or water vapour, principally due to their porosity. Moreover, other ceramics have been proposed apart from LiPON®, for example in the document WO 02/47187, but ceramics are fragile and do not withstand mechanical loads.

Yet, over time, the functioning of the microbattery implies, in particular, variations in the temperature of the elements, and thus also of any protective layer of said elements. These variations lead to considerable thermomechanical loads on said elements and their protective layer.

Improvements to existing protective layers are therefore necessary, particularly as regards their resistance.

### DESCRIPTION OF THE INVENTION

The invention proposes offsetting the disadvantages brought about by existing coating layers.

For one of its aspects, the invention concerns a protective layer for a microbattery formed of a material, metal or metal alloy, sufficiently soft and/or flexible to absorb considerable deformations without causing fissures to appear. The appearance of fissures in a coating layer is indeed detrimental to the functioning of a device sensitive to air.

Moreover, it is desirable that the protective layer itself is not very reactive with air, and/or not very reactive chemically with the constituents of the element to be protected, and in particular with lithium within the scope of microbatteries. It is moreover preferable that it also has a good mechanical compatibility with the constituents of the element to be protected, and particularly a good adhesion.

In particular, the material of the layer is selected to have a good thermomechanical resistance. According to one of the aspects of the invention, the material is chosen among rigid materials having a low expansion coefficient, in particular less than 6.10^{-6°} C.⁻¹: during the temperature variations inherent in the functioning of a microbattery for example, the material remains identical to itself, without reacting to the stresses caused by thermomechanical loads.

The protective layer may be formed of a pure metal, or a nitrated alloy that associates, with its thermomechanical resistance, a reinforced protection against oxidation. It is also possible to opt for a combination of said materials, such as for example a layer of metal combined with a layer of its nitrated alloy.

The protective layer may also be combined with another protective layer in which the material has a very ductile behaviour, in other words it deforms in a plastic manner when subject to thermomechanical stress without being damaged. Advantageously, its Vickers hardness is less than 50, preferably 40, which implies a very low elastic limit.

In order, among other things, to assure an electrical insulation of the protective layer, for example if the electrodes forming a microbattery are coated by said layer, advantageously, the protective layer according to the invention is associated with an insulating layer. Said insulating layer can also provide a first barrier towards air.

In a preferred manner, the protective layer is applied on a microbattery, which is object of this invention. Advantageously, in the case of a bilayer, the insulating layer is located on the side of the elements of the microbattery, the layer containing the metal being exterior. The preferred embodiment concerns a microbattery completely encapsulated in this layer.

The invention further concerns a method for protecting against air and/or its constituents comprising the coating by a protective layer of metal and/or of metal alloy capable of absorbing thermomechanical deformations such as described above. In particular are used W and/or Ta and/or Mo and/or Zr and/or WNₓ and/or TaNₓ and/or MoNₓ and/or ZrNₓ and/or TiNₓ and/or AlNₓ (x<1), associated if necessary with Pd and/or Pt and/or Au.

In a preferred manner, the method comprises the coating by an insulating layer before the coating by the layer containing the metal.

It is possible to conduct, before the final coating, preliminary encapsulation, which may be retained or eliminated, for example by argon plasma.

Advantageously, the different coatings are carried out by physical vapour deposition, evaporation, vaporisation or sputtering, in order to control as much as possible the parameters of the coating.

### BRIEF DESCRIPTION OF DRAWINGS

The figure is a schematic representation of the different constituents of a microbattery comprising an encapsulation layer according to the invention.

### DETAILED DESCRIPTION OF SPECIFIC EMBODIMENTS

A microbattery (10) comprises the substrate (1), the cathode (2a) and anode (2b) collectors, the cathode (3), the electrolyte (4) and the anode (5). In order to enable the exterior connection of the electrodes (8a, 8b), an encapsulation opening is formed on the cathode (2a) and anode (2b) collectors. In another variant, the connection of the microbattery to an integrated circuit or to a redistribution substrate is carried out directly on said substrate and the connection is formed directly on the bond pads of an ASIC located under the microbattery, or by the intermediary of vias through the ASIC located under the microbattery.

The microbattery (10) as such is formed by known techniques. Within the scope of the embodiment of this invention, it is moreover protected by ceramic (6) and metallic (7) encapsulation layers.

The electrodes (3, 5), particularly when they are in lithium, are indeed very reactive to air. It is therefore desirable to coat them with a protective layer. However, the other elements (2, 4) can also react with air and it is advantageous to completely encapsulate the microbattery in the bilayer (6, 7).

The protection of the constituent elements of the microbattery vis-á-vis air is principally assured by an impervious metallic layer (7), metals having a lower permeability to air than ceramics and polymers. In order not to damage the microbattery, the encapsulation layer according to the invention remains intact and fully covering, exempt of fissures.

Yet, when it functions, a microbattery undergoes temperature variations that induce considerable thermomechanical loads. In order to reduce the stresses brought about by thermomechanical loads, and to maintain these stresses at a sufficiently low level so as not to cause deteriorations, the material is sufficiently flexible to absorb the resulting deformations.

In particular, one uses a rigid material having a low expansion coefficient. This material may be associated with a material having a very ductile behaviour allowing it to deform in a plastic manner without being damaged.

Thus, the protective layer (7) is formed either of a pure metal, or an alloy, chosen among the following elements or compounds: W, Ta, Mo, Zr, WNₓ, TaNₓ, MoNₓ, ZrNₓ, TiNₓ, AlNₓ, (x<1). It may also be formed of a multilayer of these metals and/or alloys.

The metals have been chosen because they are refractory materials with a low expansion coefficient (W, Ta, Mo, Zr), less than 6.10^{-6°} C.⁻¹. Moreover, they offer an additional advantage in that they are not very reactive to air and its components: W, Ta, Mo, Zr are very resistant to oxidation.

Other materials also have a low expansion coefficient associated with a reinforced protection against oxidation; these are the nitrated alloys WNₓ, TaNₓ, TiNₓ, AlNₓ, ZrNₓ, and MoNₓ, (x<1).

Naturally, it is possible to proceed with a heterogeneous metallic layer or a multilayer, in that for example a metal and a metal nitride are used for the coating.

In particular, the protective layer (7) may be a multilayer comprising a highly ductile metal, which has a very low elastic limit (Vickers hardness less than 50, preferably less than 40). Preferably, Pd, Pt, Au are chosen, since they offer the additional advantage of being non-oxidisable.

In order to assure an electrical insulation of the electrodes of the microbattery, a first layer of electrically insulating coating (6) is applied in direct contact with the microbattery and its substrate. This layer is also chemically stable and mechanically compatible with the microbattery. Moreover, this layer can provide a first barrier towards air. Within the scope of the invention, this layer (6) will, in particular, be chosen among:
a) an oxide in which the oxide is more stable than the oxide of lithium: namely oxides of Mg, Ca, Be, Ce and La;
b) a “simple” oxide: SiO₂, MgAl₂O₄, Al₂O₃, Ta₂O₅;
c) a sulphide: zinc sulphide: ZnS;
d) a “simple” nitride: Si₃N₄, BN;
e) a carbide: SiC, B₄C, WC.

The encapsulation (6, 7) thereby formed is, in particular, impervious to H₂O, O₂ and N₂. It is chemically and physically compatible with the constituent elements (2-5) of the microbattery and its substrate (1). It electrically insulates the cathode and anode. Moreover, its other advantage lies in the fact that it can be formed at low temperature (<150° C.), and with methods compatible with micro-electronics.

One of the embodiments of an encapsulation according to the invention will now be described.

The microbatteries as such are formed in a conventional manner in an equipment, consisting of a succession of housings, enabling the successive deposition of the different materials constituting the microbattery. The transfer between each housing is carried out via a hermetic enclosure under dried argon protection enabling the exposure to air to be limited. For the coating, one could either integrate in this existing device an additional housing necessary for the encapsulation, or form on the microbatteries a temporary pre-encapsulation layer in situ, in specific microbattery manufacturing equipment, enabling the transfer of the formation device to the different encapsulation housings. This very thin temporary pre-encapsulation layer may be formed, for example, by vapour phase chemical deposition from a HMDSO (hexamethyldisiloxane) type precursor. One could also use a polymer deposited by centrifugation or a thin laminated film.

Once the microbattery has been formed on the substrate and pre-encapsulated, it is transferred into a deposition housing for the deposition of the first layer of electrically insulating ceramic. It is clear that, just as in the formation of the microbattery itself, it is possible to treat in parallel several microbatteries for the coating, by transferring them all into the deposition housing.

Depending on the ceramic to be deposited, the type of sputtering housing will be of the radiofrequency or ion beam sputtering (IBS) type or any other appropriate equipment. Indeed, it is possible to use a PVD (physical vapour deposition) technique and preferably a technique such as IBS, which allows very low deposition temperatures (down to below 100° C.). The temporary pre-encapsulation layer may be eliminated by a first step of argon plasma or left as such if it does not adversely affect the adhesion of the ceramic layer. The deposition of ceramic is carried out at the desired thickness, preferably between 25 nm and 10000 nm, or even less than 5000 nm; the rate of deposition of the ceramic layers is around 200 nm/hour.

A second metallic deposit is then formed in the same way by a PVD technique or by evaporation. This step normally takes place in another deposition housing: indeed, the configuration of the sputtering housing for the metals is generally different, of the magnetron or direct current type. In the case of deposits of compounds of type WNₓ, TiNₓ, ZrNₓ, MoNₓ or AlNₓ, nitrogen is moreover introduced into the deposition housing for forming a deposit by reactive sputtering. The rate of deposition of the metallic layers is around 2 μm/hour; in general, the thickness is between 50 nm and 10000 nm.

For the following examples, the imperviousness of the layers was tested by placing the encapsulated microbatteries in a strongly oxidising atmosphere at raised temperature (85° C./85% relative humidity).
Deposition of ZnS (100 nm)+W (100 nm)
Deposition of MgO (100 nm)+Ta (100 nm)
Deposition of SiO₂ (100 nm) +W (100 nm) +WNₓ (100 nm)
Deposition of SiO₂ (100 nm)+AlNₓ (100 nm)
Deposition of A1₂O₃ (100 nm)+W (100 nm) No deterioration of the characteristics of the microbatteries after a duration of 200 h was observed.

Finally, the microbattery thereby protected may, depending on the types of application, be encapsulated and interconnected by. various known techniques within systems (known, for example, as “packaging”), enabling its use at a later date.

1-25. (canceled)

26. Energy storage device comprising at least one anode, a dielectric and a cathode, in which the elements are coated in part at least by a protective layer formed of a metal or metal alloy having a sufficient thermomechanical resistance to absorb thermomechanical deformations without causing fissures to appear, the metal or the metal alloy having an expansion coefficient less than 6.10^{-6°} C.⁻¹.

27. Device according to claim 26, the protective layer being formed of a metal chosen among the group W, Ta, Mo, and Zr.

28. Device according to claim 26, the protective layer being formed of a nitrated alloy chosen among the group WNₓ, TaNₓ, MoNₓ, ZrNₓ, TiNₓ, and AlNₓ, where x<1.

29. Device according to claim 26, comprising at least one other protective layer formed of a metal or metal alloy having a sufficient thermomechanical resistance to absorb thermomechanical deformations without causing fissures to appear.

30. Device according to claim 29, wherein another protective layer is formed of a metal having a Vickers hardness less than 50.

31. Device according claim 30, wherein the metal is chosen among the group Pd, Pt, and Au.

32. Device according to claim 26, further comprising an electrically insulating layer.

33. Device according to claim 32, wherein the insulating layer is located between the elements of the device and the metallic protection layer(s).

34. Device according to claim 32, wherein the insulating layer is an oxide.

35. Device according to claim 34, wherein the oxide is chosen among the oxides of Mg, Ca, Be, Ce, Si, Al, Ta and La.

36. Device according to claim 32, wherein the insulating layer is a sulphide.

37. Device according to claim 32, wherein the insulating layer is a nitride.

38. Device according to claim 37, wherein the nitride is chosen among Si₃N₄ and BN.

39. Device according to claim 32, wherein the insulating layer is a carbide.

40. Device according to claim 39, wherein the carbide is chosen among SiC, B₄C, and WC.

41. Device according to claim 26, wherein the elements are encapsulated in the protecting and/or insulating layer(s).

42. Method for protecting an energy storage device comprising the coating of a part at least of the device by a protective layer formed of a metal or metal alloy having a sufficient thermomechanical resistance to absorb thermomechanical deformations without causing fissures to appear, the metal or the metal alloy having an expansion coefficient less than 6.10^{-6°} C.^{31 1}.

43. Method according to claim 42, comprising the coating of a part at least of the device by a protective layer formed of a metal having a Vickers hardness less than 50.

44. Method according to claim 42, where the coating(s) are formed by physical vapour deposition or evaporation.

45. Method according to claim 42, comprising, prior to the coating(s) by metallic layer(s), the step of coating by an electrically insulating layer.

46. Method according to claim 45, in which the insulating layer is a ceramic chosen among ZnS, Si₃N₄, BN, SiC, B₄C, WC, MgAl₂O₄ and the oxides of Mg, Ca, Be, Ce, La, Si, Al or Ta.

47. Method according to claim 45, wherein the coating by an insulating layer is carried out by physical vapour deposition, radiofrequency sputtering or ion beam sputtering.

48. Method according to claim 45, comprising, prior to the coating by the insulating layer, a step of pre-encapsulation.

49. Method according to claim 48, comprising the elimination of the pre-encapsulation layer before the coating by the insulating layer.

50. Method for protecting a microbattery comprising the encapsulation of the microbattery by the method according to claim 42.
